(19) United States
(12) Patent Application Publication
(10) Pub. No.: US 2024/0198351 A1
(43) Pub. Date: Jun. 20, 2024

(54) ELECTRONIC CIGARETTE BUTT DISPOSAL DEVICE

(71) Applicant: Vladimir Janicijevic, Elmwood, IL (US)

(72) Inventor: Vladimir Janicijevic, Elmwood, IL (US)

(21) Appl. No.: 18/084,510

(22) Filed: Dec. 19, 2022

(51) Int. Cl. B02C 18/00; A24F 47/00; B02C 18/18

(52) U.S. Cl. CPC B02C 18/0084; A24F 47/00; B02C 18/182

(57) ABSTRACT

A cigarette filter and butt shredder device includes a housing; a shredder within the housing; a waste container within the housing adjacent to the shredder, an electric motor within the housing to drive the shredder, a power source within the housing to power the electric motor, the power source adjacent to the shredder and waste container, and a switch to activate the electric motor.

### FIELD OF THE INVENTION

The present invention relates generally to an apparatus for cigarette disposal. More particularly, the present invention is related to an electronic device for shredding cigarette butts, in particular their filters, to facilitate disposal.

### BACKGROUND

Disposal of cigarette butts remains an issue. Often, cigarette butts are piled in ashtrays where, besides creating a feeling of untidiness and dirtiness, they can generate an unpleasant smell and, if not completely put out, partial combustion of the filters.

Accordingly, there is a need for a better means to dispose of cigarette butts. The invention disclosed in the present disclosure is aimed towards improving cigarette butt disposal, at least in part by shredding the butt of the cigarette to facilitate disposal. Accordingly, when shredded, cigarette butts biodegrade much quicker. Further, shredding cigarette butts eliminates the unpleasant sight and smell of said butts.

### SUMMARY OF THE INVENTION

Accordingly, there is a need for a better means to dispose of cigarette butts. The invention disclosed in the present disclosure is aimed towards improving cigarette butt disposal, at least in part by shredding the butt of the cigarette to facilitate disposal. Accordingly, when shredded, cigarette butts biodegrade much quicker. Further, shredding cigarette butts eliminates the unpleasant sight and smell of said butts.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention are directed towards an electronic cigarette butt shredding device. In the preferred embodiment, the electronic cigarette butt shredder device comprises a housing, the housing comprising a top side, a bottom side, front side, a back side, a left side, and a right side; a shredder within the housing; a waste container within the housing adjacent to the shredder; an electric motor within the housing to drive the shredder; a power source within the housing to power the electric motor, the power source adjacent to the shredder and waste container; and a switch to activate the electric motor.

The device further comprises a passage in communication with the shredder, the passage of a diameter to receive a cigarette. In some embodiments, the passage is of a length equivalent to that of a cigarette filter. The device further comprises a cap to cover the passage. A user may press down the cap to push a cigarette butt down through the passage into the shredder.

In some embodiments, the shredder is a single-shaft vertical shredder comprising a corkscrew-pattern blade arrangement, said arrangement configured to cause the shredder to grab onto a cigarette butt fed into the passage. In some other embodiments, the shredder is a dual-shaft shredder. In some other embodiments, the shredder is a triple-shaft shredder. In some other embodiments, the shredder is a four-shaft shredder. In some other embodiments, the device comprises a combination of vertical and horizontal shredding mechanisms.

The device further comprises a screen disposed below the shredder to prevent a cigarette butt particle having a particle size greater than a desired size from passing into the waste container. In the preferred embodiment, the waste container is detachable from the rest of the housing.

In some embodiments, the device further comprises a trap door in communication with the passage to allow receipt of a cigarette butt into the passage. In some embodiments, the device further comprises a trap door switch to actuate the trap door.

In some embodiments, the power source is a rechargeable battery. In some embodiments, the rechargeable battery is a motion charged rechargeable battery.

In some embodiments, the device further comprises a speed-controller configured to adjust the shredder between a first speed setting and a second speed setting.

In some embodiments, the device further comprises a sensor system configured to detect a presence of a butt on the shredder and actuate the shredder upon detection of the presence of the butt.

### BRIEF DESCRIPTION OF THE DRAWINGS

The following drawings are intended to serve as exemplary embodiments of the features disclosed in the present disclosure.

FIG. 1 is a diagram illustrating an exemplary electronic cigarette butt disposal device.

FIG. 2 is a diagram illustrating an exemplary electronic cigarette butt disposal device comprising a single-shaft vertical shredder.

FIG. 3 is a diagram illustrating an exemplary electronic cigarette butt disposal device comprising a multi-shaft vertical shredder.

FIG. 4 is a diagram illustrating an exemplary electronic cigarette butt disposal device comprising a single shaft horizontal shredder.

FIG. 5 is a diagram illustrating an exemplary electronic cigarette butt disposal device comprising a double shaft horizontal shredder.

FIG. 6 is a diagram illustrating an exemplary electronic cigarette butt disposal device comprising a triple shaft horizontal shredder.

FIG. 7 is a diagram illustrating an exemplary electronic cigarette butt disposal device comprising a four shaft horizontal shredder.

FIG. 7 is a diagram illustrating an exemplary electronic cigarette butt disposal device comprising a four shaft horizontal shredder.

FIG. 8 is a circuit diagram illustrating an exemplary circuit configured to perform the functions of said device.

FIG. 9 is a flowchart illustrating an exemplary method of use of said device.

### DETAILED DESCRIPTION OF DRAWINGS

The description of illustrative embodiments according to principles of several illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits are illustrated by reference to certain exemplified embodiments and may not apply to all embodiments.

Accordingly, the invention expressly should not be limited to such exemplary embodiments illustrating some possible non-limiting combination of features that may exist alone or in other combinations of features; the scope of the claimed invention being defined by the claims appended hereto.

This disclosure describes the best mode or modes of practicing the invention as presently contemplated. This description is not intended to be understood in a limiting sense but provides an example of the invention presented solely for illustrative purposes by reference to the accompanying drawings to advise one of ordinary skill in the art of the advantages and construction of the invention. In the various views of the drawings, like reference characters designate like or similar parts.

The various embodiments described herein describe an electronic cigarette butt disposal device. In the preferred embodiment, the device comprises an electrically powered pocket-sized shredder. In general, the basic elements of a shredder may include a housing, a rotor, a counter blade or counter blades, motor, power system, and a control system. The housing contains all of the components of the shredder and may comprise of a heavy-duty metal. The rotor on a shredder may have saw teeth cutters that mesh with knives to shred scrap and waste. The blades are selected to fit the material to be shredded since not all blades can be used on all materials. The blades may comprise of hardened alloyed steel and may be coated to add to their useful life. The motor on a shredder generally operates at a slow speed to lessen its stress. The slow rotating speed and high torque allows the shredder to shred a variety of materials. The electric power system powers the motor to rotate the rotor. The shredder grabs the material, in which the shredder effectively takes the material and pulls it down into the cutting blades. Grabbing as a function of the shredder is determined by the size and shape of the cutter hook as well as the texture and weight of the material. Control systems allow for in process adjustments to shredding eliminating the need to access the mechanism to make changes and adjustments.

It is contemplated that an electronic shredder is advantageous, and superior compared to a manual shredder. Accordingly, an electronic shredder does not depend on the strength of a user to operate. Further, an electronic shredder may be easier to operate by individuals lacking adequate mobility of their hands to operate a manual shredder. Further, an electronic shredder is able to shred butts quicker and more efficiently than a manual shredder.

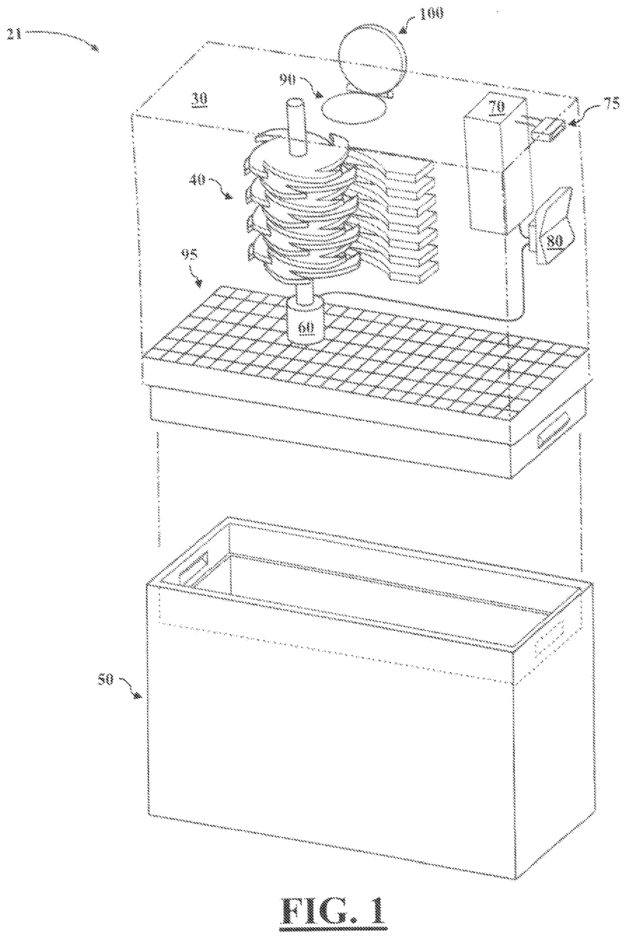

FIG. 1 is a diagram illustrating an exemplary electronic cigarette butt disposal device. The cigarette butt disposal device 21 generally includes a housing 30, a shredder mechanism 40, a waste container 50, an electric motor 60 to power the shredder 40, a power source 70 to power the electric motor 60 and a switch 80 to activate the electric motor 60.

The housing 30 may comprise of a top side, a bottom side, a front side, a back side, a left side, and a right side. Further, the housing may further comprise a passage 90 disposed on the top side of the housing, the passage 90 extending parallel to the font side, back side, left side, and right side, and perpendicular to the bottom side.

The passage 90 is in communication with the shredder mechanism 40 transverse to the shredder mechanism 40. The passage 90 may be of a diameter to receive a cigarette and may be of a length equivalent to that of a cigarette filter. In one embodiment, the passage 90 may be about 25-30 mm in length and about 8-10 mm in diameter. A hinged cap 100 may be used to close the passage 90.

The housing 30 may be of a rectilinear shape and manufactured of a material to contain and extinguish any lit embers such as stainless steel. Closure of the hinged cap 100 assures that the filters, butts and any remaining embers are extinguished. A charging port 75 provides a means to utilize an outside power source to recharge batteries.

The shredder mechanism 40 may comprise of a shaft or rotor covered with a plurality of teeth or blades, and a screen 95 underneath to filter materials to conform to the proper size.

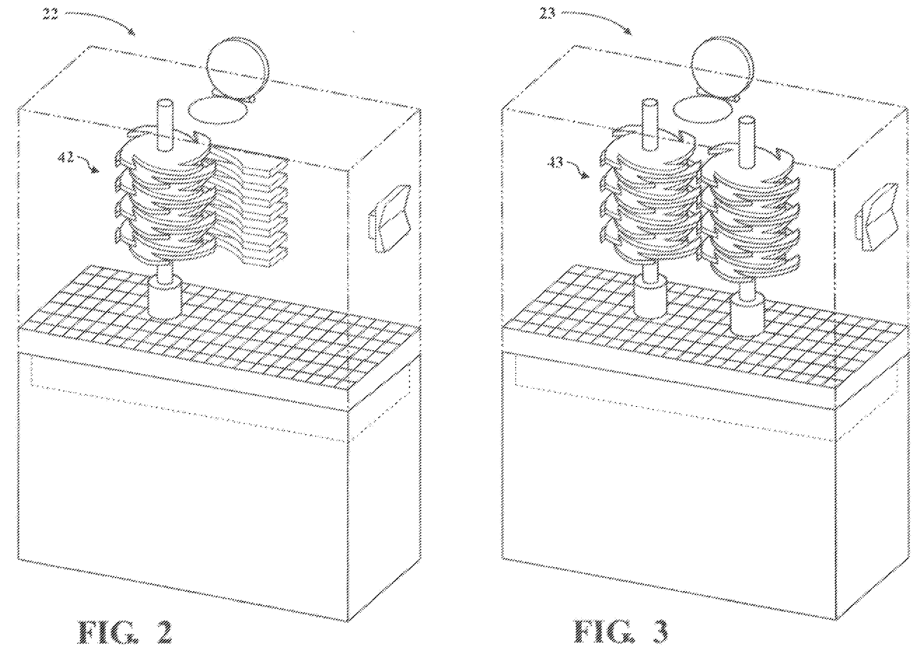

FIGS. 2-7 illustrate additional exemplary embodiments of the cigarette butt disposal device 21. It is understood that the other embodiments illustrated by FIGS. 2-7 may be configured in the same manner as device 21, even if some details are omitted from the other drawings. FIGS. 2-7 depict different exemplary embodiments of the present invention, wherein the embodiments differ only with respect to the shredding mechanism used within the device.

FIG. 2 illustrates an exemplary device 22 comprising a single shaft vertical shredder 42. In some embodiments, the shredder mechanism 42 is a single shaft shredder. The device 22 shown in FIG. 2 is understood to comprise the same components as the device 21 shown in FIG. 1. Accordingly, the shredder 42 may comprise a single shaft vertical shredder including at least one shaft with rotary blades, and a screen underneath to filter materials to conform to the proper size. The single shaft rotates at a desired RPM rate suitable to shred a cigarette butt filter. In said embodiment, the shaft covered with blades is parallel to the passage 90. The user may insert a cigarette butt into passage 90, and then close the hinged cap 100 on top of the butt. When the user presses down on the cap 100 the butt is forced through the passage 90 and fed into the shredding mechanism. In some embodiments, the device includes a sensor configured to detect the presence of a butt, and actuate the shredding mechanism upon detection of a presence of a butt. Accordingly, the shredding mechanism stays activated until the pieces of the butt are small enough to drop through the screen. In some other embodiments, the device may include a switch that when pressed actuates the shredding mechanism.

In some embodiments, the blades disposed on the single shaft vertical shredding mechanism 42 are arranged in a corkscrew pattern. Accordingly, said corkscrew pattern is configured to allow the vertical shaft to grab onto a butt inserted into the passage 90. Accordingly, when a butt is inserted into the passage 90, the shaft comprising a corkscrew pattern blade arrangement grabs onto the butt, and pulls the butt down through the passage 90 until the butt is pressing against the screen. The shredding mechanism continues to push the butt against the screen until the pieces are small enough to fall through the screen. Further, the corkscrew design prevents cigarette butt pieces from moving upward through the passage.

FIG. 3 is a diagram illustrating an exemplary electronic cigarette butt disposal device 23 comprising a multi-shaft vertical shredder 43. The device 23 shown in FIG. 3 is understood to comprise the same components as the device 21 shown in FIG. 1, except for the shredding mechanism 43.

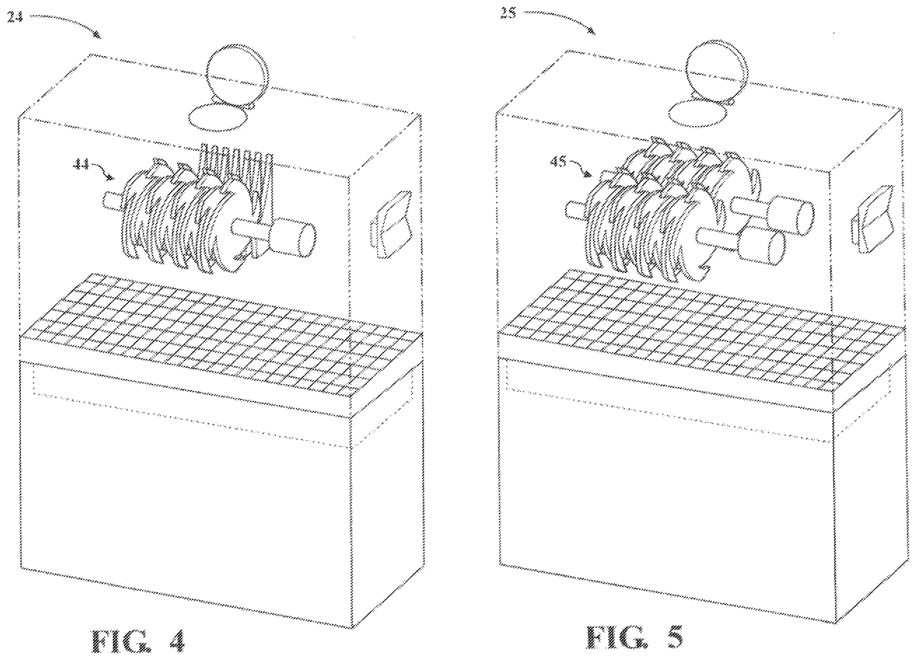

FIG. 4 is a diagram illustrating an exemplary electronic cigarette butt disposal device 24 comprising a single shaft horizontal shredder 44. Accordingly, the shredder may comprise a single shaft horizontal shredder including at least one shaft with rotary blades, and a screen underneath to filter materials to conform to the proper size. The device 24 shown in FIG. 4 is understood to comprise the same components as the device 21 shown in FIG. 1, except for the shredding mechanism 44.

FIG. 5 is a diagram illustrating an exemplary electronic cigarette butt disposal device 25 comprising a double shaft horizontal shredder 45. In some embodiments, the shredder mechanism 45 may be a double shaft shredder. Accordingly, the shredder may comprise a dual shaft shearing shredder, comprising shearing blades that are mounted on two shafts that rotate into each other at a desired speed. It is contemplated that each of the shafts may be rotated at a slower speed than a single shaft would be rotated, to achieve less noise and create less dust while shredding. The device 25 shown in FIG. 5 is understood to comprise the same components as the device 21 shown in FIG. 1, except for the shredding mechanism 45.

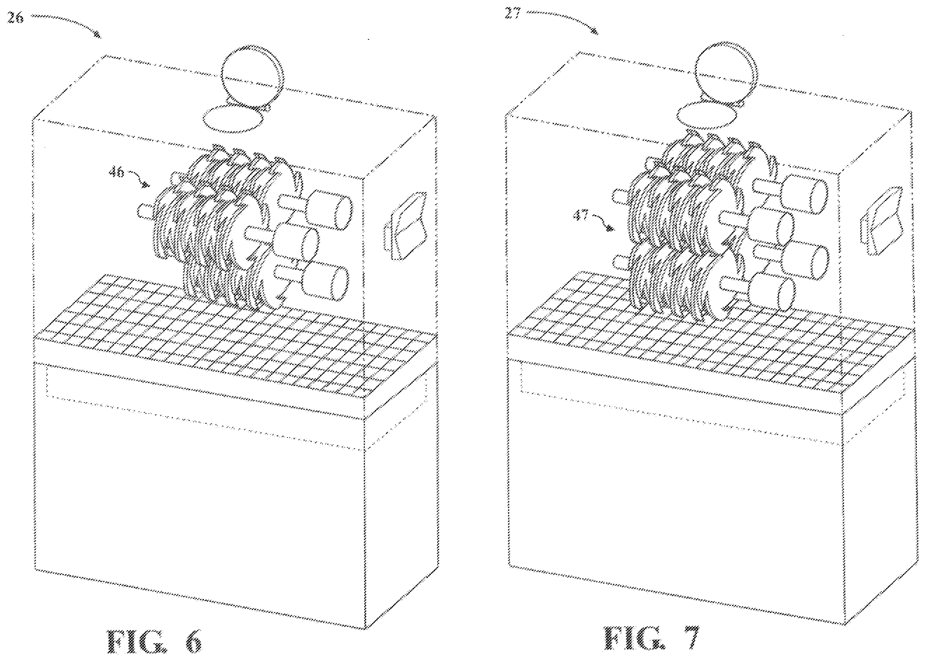

FIG. 6 is a diagram illustrating an exemplary electronic cigarette butt disposal device 26 comprising a triple shaft horizontal shredder 46. In some embodiments, the shredder mechanism 40 may be a triple shaft shredder. Accordingly, the shredder may include shafts comprising three sets of blades rotating at different speeds. The size selection for shredded materials is determined by the screen 95 that the material has to pass through when leaving the shredding chamber. If the butt piece is not small enough, it is recirculated through the machine until it is the proper size to pass through the screen 95. The device 26 shown in FIG. 6 is understood to comprise the same components as the device 21 shown in FIG. 1, except for the shredding mechanism 46.

FIG. 7 is a diagram illustrating an exemplary electronic cigarette butt disposal device comprising a four shaft horizontal shredder 27. In some embodiments, the shredder mechanism 47 may be a four-shaft shredder. Accordingly, the shredder mechanism 40 may include a four-shaft shredder comprising four shearing rollers with four sets of shearing knife rollers with different cutting shapes. A four-shaft shredder allows for pre-shredding and secondary shredding to happen simultaneously, which improves shredding efficiency. Accordingly, the cigarette butt may pass may through a first set of rollers to reduce to the butt into pieces of a certain size and sent through a second set of rollers to further reduce the butt pieces into even smaller sized pieces. The device 27 shown in FIG. 7 is understood to comprise the same components as the device 21 shown in FIG. 1, except for the shredding mechanism 47.

In some embodiments, the device comprises a combination of vertical and horizontal shredders. It is contemplated that any combination of any number of vertical and horizontal shredders may be used. For example, a vertical shredder with a corkscrew blade pattern arrangement may initially grab a butt and subsequently pull the butt down into a multishift horizontal shredder configuration.

In the preferred embodiment, as shown in FIG. 1, the device 21 further comprises a screen 95 configured to prevent cigarette butt filter pieces of a certain size from passing through into the waste container 50, causing the shredder to continue to shred the pieces until they are of a small enough size to pass through the screen 95 into the waste container 50. In some embodiments, the screen 95 is a flat surface comprising a plurality of holes or slots disposed along the entirety of the surface, wherein each hole or slot is of a diameter or size large enough to accommodate a tiny piece of a cigarette filter and butt. In some embodiments, the filter is a mesh filter.

In the preferred embodiment, as shown in FIG. 1, the device 21 further comprises a shredder switch 80 coupled to the side of the housing 30 for activating the shredder mechanism 40. Accordingly, the switch 80 may be a push button connected to a circuit that when pressed by a user, completes the circuit allowing the power supply 70 to power the motor and drive the shredder mechanism 40. In some embodiments, the switch 80 is a Single Pole Single Throw Switch (“SPST”). In some embodiments, the switch 80 is a toggle switch. In some embodiments, the switch 80 is a joystick switch. In some embodiments, the switch 80 is an electronic switch.

In some embodiments, the shredder mechanism may further comprise a sensor system configured to detect the presence of an object touching the shredder 40 and activate the shredder 41 upon detection of an object resting on the shredder. When a butt touches the cutting head, a sensor activates and the sharp teeth or knives rotate and pull the butt into their jaws. In said embodiment, the shredder mechanism 41 activates upon a user dropping a cigarette butt into the device 21. When the cigarette butt touches the shredder 41, the shredder activates and begins to shred the butt, and continues to shred the butt until the presence of the butt is no longer detected on the shredder 40.

In some embodiments, the device further comprises a speed-controller coupled to the motor 60. The speed-controller may be used to adjust the speed of the motor 60, and the speed of the rotation of the shredder 40. It is contemplated that different speeds may be suitable to different types of cigarette butts or filters. For example, a cigarette filter comprising hemp may require more force to shred than a cigarette filter comprising cellulose acetate. It is contemplated that the speed-controller may be used to configure the shredder 40 between a “LOW” setting and a “HIGH” setting.

In the preferred embodiment, as shown in FIG. 1, the device further comprises a passage switch configurable to open the cap 100. Further, in some embodiments, the device passage 90 is exposed by pressing a passage switch that activates a trap door style opening. Accordingly, when a user presses the passage switch, the trap door opens inward (or outward) to reveal the passage 90. When the user releases the switch, the trap door closes and the housing 30 is once again sealed.

In the preferred embodiments, as shown in FIG. 1, the entire waste container 50 is removed from the device in order to dispose of the waste material. This allows the user to thoroughly wash and sanitize the waste container 50 and device separately, before inserting the waste container back into the body of the device.

In some embodiments, the device further comprises a waste container door for opening the waste container 50 to facilitate disposing debris from the waste container 50. The waste container door is disposed on the bottom of the housing 30. In some embodiments, the waste container door is attached to the housing 30, and the housing bottom consists of the waste container door. The waste container door may be attached to the housing 30 by a hinge. Further, the waste container door may comprise of a tab, and the housing 30 may comprise a region defined by an indent, wherein the indent is an accommodating size for the tab, so that when the tab is inserted into the indent the waste container bottom is securely attached to the housing 30.

In some embodiments, the waste container door may be actuated by a waste container door switch, whereby pressing the switch release the tab from the indent, allowing the waste container door to open automatically by the effect of gravity, or allowing a user to open the door manually.

In one embodiment, the power source 70 may be a rechargeable battery or may include disposable batteries. The power source 70 may form an entire half of the housing 30 to provide long-lasting operation. That is, the power source 70 may be of a size equivalent to both the shredder 40 and the waste container 50 sections. It is contemplated that the battery may be any type of rechargeable battery, including but not limited to, a lead-acid battery, a nickel-cadmium (“NiCd”) battery, a nickel-metal hydride (“NiMH”) battery, a lithium-ion (“Li-ion”) battery, a nickel-zinc (“NiZn”) battery, a lithium-ion polymer (“LiPo”) battery, an alkaline battery, or any other suitable rechargeable types and/or any combination thereof. In some embodiments, the power source 70 comprises a motion powered battery assembly configured to convert kinetic energy to electrical energy. Accordingly, the motion powered battery assembly may be configured to convert the kinetic energy produced by a user while walking with the device their pocket into electrical energy that may be stored and readily used to energize the device 21. In some embodiments, the device 21 may include a USB charging port 75 and the device battery 70 may be recharged by connecting the device 21 to any type of USB charger.

Various exemplary embodiments of the invention described in the present disclosure may be implemented using electronic circuitry configured to perform one or more functions. In accordance with the present disclosure, the term “circuit” refers to a collection of electrical components coupled together to create a device or system powered by electrical voltages. The circuit may be self-contained within the housing 30 of the device 21.

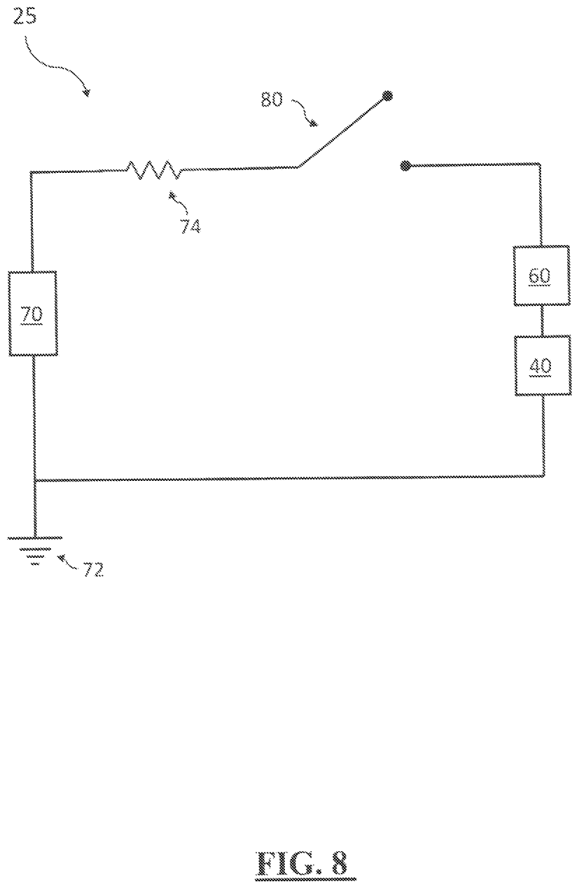

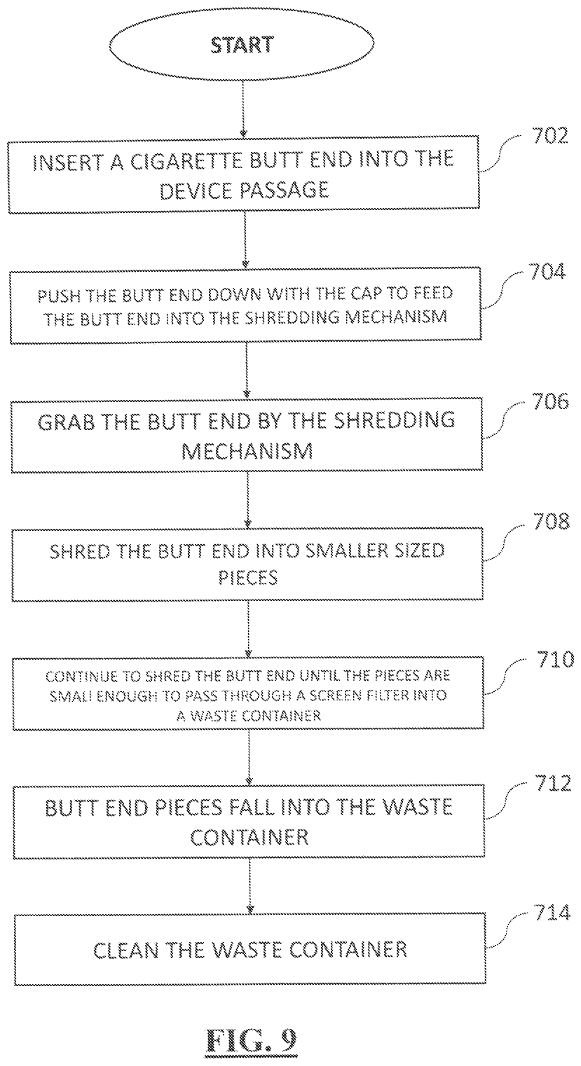

FIG. 8 is a circuit diagram illustrating an exemplary circuit 25 configured to perform the functions of the present invention. Accordingly, the circuit generally comprises a shredder 40, a power source 70 to power the electric motor 50 and a switch 80 to activate the electric motor 60. The power source 70 is electrically coupled to the motor 60 which is further coupled to a shredding mechanism within the device. The electric motor is an electrical machine that converts electrical energy into mechanical energy. The motor operates through the interaction between the motor's magnetic field and electric current in a wire winding to generate force in the form of torque applied on the motor's shaft. The motor's shaft is connected to at least one shaft of the shredding mechanism employed in the device, thereby achieving rotation of the at least one shaft of the shredding mechanism. The electric motor may be powered by direct current (DC) sources, such as from batteries, or rectifiers, or by alternating current (AC) sources. In some embodiments, the motor is a brushed motor. In other embodiments, the motor is a brushless motor. In some embodiments, the motor is a single-phase motor. In some other embodiments, the motor is a multi-phase motor. In some embodiments, the motor is air-cooled. In some other embodiments, the motor is liquid-cooled. The circuit 25 may further comprise a resistor 74, and a ground element 72. The resistor may be any resistance suitable to achieve an appropriate electrical current at which to operate the device.

The function of the device 21 may be performed in the following exemplary manner: an individual cigarette filter and butt are inserted into the passage 90 and the switch 80 is activated to shred the cigarette filter and butt and the shredded remains fall into the waste container 50. The hinged cap 100 may then be closed to provide a sealed housing to seal in smell and any embers where they are extinguished.

FIG. 9 is a flowchart illustrating an exemplary method of using the device described in the present disclosure. With reference to FIG. 8, first, at step 702, a cigarette filter and butt to be shredded are fed into the passage 90 of the device 21. Next, the butt is grabbed by the blades and pulled through the knives or cutters disposed on the shredder 40. Next, at step 704, a user presses the cap 100 down on the cigarette butt end, in order to press the cigarette butt end into the shredding mechanism. In case the shredding mechanism does not grab the butt right away, the user may continue to press down and apply pressure on the cap 100 until the butt is fed through the shredder. Next, at step 706, the butt is grabbed by the shredding mechanism. Accordingly, the shredder or cutting mechanism grabs the butt and pulls it through the rotating blades, changing the whole butt into small pieces.

Next, at step 708, as the butt passes through the shredder 40, it is cut into shapes of various sizes depending on the material being shredded and the design of the shredder. In some embodiments, a secondary or granulator may be used to further reduce the size of pieces.

Next, at step 710, the butt continues to be shred until the butt pieces are of a small enough size to pass through a screen or filter 95. The screen disposed adjacent to the shredding blades ensures that the cigarette butt pieces reach a specific desired small enough size. In some embodiments, the shredder screens 95 align with the rotating cutter such that there is an interaction between the cutter and screen 95.

Next, at step 712, once the pieces are small enough to pass through the filter, the pieces fall into the waste container 50, which holds the remnants and pieces of the cigarette filter and butt. Finally, at step 714, when the waste container is full, the user may open the bottom of the housing 30 to remove the particles from the container 50, and easily clean the container 50. In some embodiments, the waste container 50 is detachable from the device, allowing the user to remove the entire waste container 50 so to be able to thoroughly clean all the parts of the device separately. It is contemplated that the waste container may be washed by hand wish ordinary soap and water or may as well be washed in a standard dishwasher.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An electronic cigarette butt shredder device, comprising
a housing, the housing comprising a top side, a bottom side, front side, a back side, a left side, and a right side;
a shredder within the housing;
a waste container within the housing adjacent to the shredder;
an electric motor within the housing to drive the shredder;
a power source within the housing to power the electric motor, the power source adjacent to the shredder and waste container; and
a switch to activate the electric motor.

2. The device as recited in claim 1, wherein the power source is a rechargeable battery.

3. The device as recited in claim 1, wherein the housing is rectilinear.

4. The device as recited in claim 1, wherein the waste container is detachable from the device.

5. The device as recited in claim 1, further comprising a passage in communication with the shredder, the passage of a diameter to receive a cigarette.

6. The device as recited in claim 5, wherein the passage is of a length equivalent to that of a cigarette filter.

7. The device as recited in claim 1, further comprising a cap to cover the passage.

8. The device as recited in claim 1, further comprising a screen disposed below the shredder to prevent a cigarette butt particle having a particle size greater than a desired size from passing into the waste container.

9. The device of as recited in claim 1, wherein the bottom side is a waste container door configured to move between an open position and a closed position, wherein the open position allows for removal of a debris from the waste container.

10. The device as recited in claim 1, further comprising a trap door in communication with the passage to allow receipt of a cigarette butt into the passage.

11. The device as recited in claim 10, further comprising a trap door switch to actuate the trap door.

12. The device as recited in claim 1, further comprising a speed-controller configured to adjust the shredder between a first speed setting and a second speed setting.

13. The device as recited in claim 1, further comprising a sensor system configured to detect a presence of a butt on the shredder and actuate the shredder upon detection of the presence of the butt.

14. The device as recited in claim 1, wherein the shredder is a single-shaft vertical shredder comprising a corkscrew-pattern blade arrangement, said arrangement configured to grab onto a cigarette filter.

15. The device as recited in claim 1, wherein the shredder is a dual-shaft shredder.

16. The device as recited in claim 1, wherein the shredder is a triple-shaft shredder.

17. The device as recited in claim 1, wherein the shredder is a four-shaft shredder.

18. The device as recited in claim 1, wherein the switch is a momentary push-button switch.

19. The device as recited in claim 1, wherein the switch is a toggle-switch.

20. The device as recited in claim 1, wherein the switch is an electronic switch.
